(19) United States
(12) Patent Application Publication
(10) Pub. No.: US 2017/0121447 A1
(43) Pub. Date: May 4, 2017

(54) POLYISOCYANATES HAVING THIOALLOPHANATE STRUCTURE

(71) Applicant: Covestro Deutschland AG, Leverkusen (DE)

(72) Inventors: Hans-Josef Laas, Odenthal (DE); Dorota Greszta-Franz, Solingen (DE)

(21) Appl. No.: 15/317,237

(22) PCT Filed: Jun. 9, 2015
(86) PCT No.: PCT/EP2015/062765

§ 371 Date: Dec. 8, 2016

(30) Foreign Application Priority Data
Jun. 13, 2014 (EP) 14172296.7

(51) Int. Cl. C08G 18/38; C08G 18/22; C08G 18/75; C09D 175/04; C08G 18/73

(52) U.S. Cl. CPC C08G 18/3876; C09D 175/04; C08G 18/73; C08G 18/755; C08G 18/222

(57) ABSTRACT

The invention relates to polyisocyanates that have aliphatically, cycloaliphatically, araliphatically and/or aromatically bonded isocyanate groups and contain thioallophanate structures of formula (I),

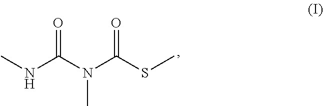

to a method for producing them, and to their use as starting components in the production of polyurethane plastics.

### CROSS-REFERENCE TO RELATED APPLICATION

This application is a national stage application (under 35 U.S.C. §371) of PCT/EP2015/062765, filed Jun. 9, 2015, which claims benefit of European Application No. 14172296.7, filed Jun. 13, 2014, both of which are incorporated herein by reference in their entireties.

### FIELD OF THE INVENTION

Polymers containing sulfur possess a range of properties that are of technical significance. As a result of the incorporation of sulfur atoms into a polymer framework, for example, the mechanical and thermal resistance properties of a plastic, and also the adhesion to metals, can be significantly improved. Furthermore, sulfur-containing polymers generally also exhibit excellent optical properties and high biocompatibility.

### BACKGROUND OF THE INVENTION

Polyurethane chemistry as well is not unfamiliar with the use of reactive components containing sulfur.

For example, polythiols are employed as coreactants for various polyisocyanate components in the production of transparent, highly refracting polythiourethane lenses (e.g., EP-A 0 422 836, EP-A 0 802 431, EP-A 1 670 852, EP-A 2 065 415, or WO 2010/148424).

Sulfur-containing polyisocyanates have likewise already been described in a range of publications.

According to the teaching of JP-A 04-117353, in particular, 1,4-bis(isocyanato-methylthio)benzene is a suitable starting isocyanate for the production of optical materials. Other sulfur-containing diisocyanates developed especially for the production of highly refractive polymeric lenses are, for example, bis(4-isocyanatomethylthiophenyl) sulfide (JP-A 04-117354), 1,2-bis(2-isocyanatoethylthio)ethane, bis[2-(isocyanato-methylthio)ethyl]sulfide, bis(isocyanatomethylthio)phenylmethane, 1,1,2,2-tetrakis(isocyanatomethylthio)ethane, and 2,2,5,5,-tetrakis(isocyanatomethylthio)-1,4-dithiane (EP-A 0 713 105), 2,5-diisocyanato-1,4-dithiane (JP-A 09-071631), tris(isocyanatomethylthio)methane (JP-A 09-071632), the tricyclic diisocyanate 2,8-diisocyanato-4-thiatricyclo[3.2.1.0^{3,6}]octane (JP-A 2001-002674), and also specific diisocanatoalkyltrithianes (JP-A 2008-174520).

These sulfur-containing diisocyanates, however, are obtainable only by way of very costly and inconvenient synthesis routes, and are not available commercially.

Isocyanate-functional semiprepolymers based on aliphatic, cycloaliphatic and/or aromatic diisocyanates and polythiols are subject matter of WO 01/36508.

These prepolymers, which may contain urethane, thiourethane, thiocarbamate and/or dithiourethane structures, serve in combination with aromatic diamines for the production of photochromic optical materials. On account of the high residual level therein of low molecular mass, monomeric diisocyanates, which are classed as toxic working materials and in some cases have a high vapor pressure, NCO prepolymers of these kinds can be processed only if stringent safety requirements are observed.

Toxicologically unobjectionable, sulfur-containing polyisocyanates, which would have broad usefulness across customary applications of polyisocyanates, as for example as crosslinker components for two-component polyurethane paints and coatings, have not hitherto been disclosed.

### SUMMARY OF THE INVENTION

The present invention provides new polyisocyanates of low monomer content, containing chemically bonded sulfur, which can be prepared safely and reproducibly from readily available raw materials in a simple process, and are suitable as starting components for a large number of different applications.

This has been achieved through the provision of the polyisocyanates described in more detail below, and the process for their preparation. The invention described in more detail below is based on the surprising observation that thiols can be reacted very selectively with molar-excess amounts of an isocyanate component, even under unexpectedly mild reaction conditions, to form thioallophanate groups, producing storage-stable products which are light in color and are distinguished by low viscosities. Such polyisocyanates with thioallophanate structure were hitherto unknown.

It is understood that the invention disclosed and described in this specification is not limited to the embodiments summarized in this Summary

### DETAILED DESCRIPTION OF THE INVENTION

The present invention accordingly provides polyisocyanates having aliphatically, cycloaliphatically, araliphatically and/or aromatically bonded isocyanate groups, comprising thioallophanate structures of the formula (I)

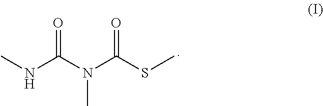

Also provided by the invention is a process for preparing such polyisocyanates by reacting
A) at least one di- and/or polyisocyanate having aliphatically, cycloaliphatically, araliphatically and/or aromatically bonded isocyanate groups with
B) at least one compound carrying at least one mercapto group, optionally in the presence of
C) a catalyst which accelerates the formation of thioallophanate groups,
   while observing an equivalents ratio of isocyanate groups to isocyanate-reactive groups of 4:1 to 200:1.

The invention, lastly, also provides the use of the polyisocyanates obtainable by this process as starting components in the production of polyurethane plastics, more particularly as a crosslinker component in polyurethane paints and coatings.

Starting compounds A) for the process of the invention are any desired diisocyanates having aliphatically, cycloaliphatically, araliphatically and/or aromatically bonded isocyanate groups, which may be prepared by any desired processes, for instance by phosgenation or by a phosgene-free route, as for example by urethane cleavage.

Suitable diisocyanates A) are, for example, those from the molecular weight range 140 to 400 g/mol, such as, for example, 1,4-diisocyanatobutane, 1,5-diisocyanatopentane, 1,6-diisocyanatohexane (HDI), 1,5-diisocyanato-2,2-dimethylpentane, 2,2,4- and/or 2,4,4-trimethyl-1,6-diisocyanatohexane, 1,8-diisocyanatooctane, 1,9-diisocyanatononane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophoronediisocyanate; IPDI), 1-isocyanato-1-methyl-4(3)-isocyanato-methylcyclohexane, 2,4′- and 4,4′-diisocyanatodicyclohexylmethane (H₁₂-MDI), 1,3- and 1,4-bis(isocyanatomethyl)cyclohexane, 4,4′-diisocyanato-3,3′-dimethyl-dicyclohexylmethane, 4,4′-diisocyanato-3,3′,5,5′-tetramethyldicyclo-hexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetra-methyl-1,1′-bi(cyclohexyl), 1,8-diisocyanato-p-menthane, 1,3-diisocyanatoadamantane, 1,3-dimethyl-5,7-diisocyanatoadamantane, 1,3- and 1,4-bis(isocyanatomethyl)benzene, 1,3- and 1,4-bis(1-isocyanato-1-methylethyl)benzene (TMXDI), bis(4-(1-isocyanato-1-methylethyl)phenyl) carbonate, 1,3- and 1,4-phenylene diisocyanate, 2,4- and 2,6-toluylene diisocyanate, and also desired mixtures of these isomers, diphenylmethane 2,4′- and/or 4,4′-diisocyanate and naphthylene 1,5-diisocyanate, and also any desired mixtures of such diisocyanates. Further diisocyanates that are likewise suitable are additionally found, for example, in Justus Liebigs Annalen der Chemie volume 562 (1949) pp. 75-136.

Likewise suitable starting components A) are any desired polyisocyanates which are comprised of at least two diisocyanates, having been prepared by modification of the abovementioned simple aliphatic, cycloaliphatic, araliphatic and/or aromatic diisocyanates, and which have uretdione, isocyanurate, allophanate, biuret, iminooxadiazinedione and/or oxadiazinetrione structure, as described by way of example in, for example, J. Prakt. Chem. 336 (1994) 185-200, specifications DE-A 16 70 666, 19 54 093, 24 14 413, 24 52 532, 26 41 380, 37 00 209, 39 00 053, and 39 28 503, or EP-A 336 205, 339 396, and 798 299.

Preferred as starting component A) are the stated simple diisocyanates having aliphatically and/or cycloaliphatically bonded isocyanate groups.

Particularly preferred diisocyanates A) for the process of the invention are 1,5-diisocyanaotpentane, 1,6-diisocyanatohexane, 1-isocyanato-3,3,5-trimethyl-5-isocyanatomethylcyclohexane, 2,4′- and/or 4,4′-diisocyanatodicyclohexylmethane, or any desired mixtures of these diisocyanates.

For preparing the polyisocyanates of the invention, the above-described di- and/or polyisocyanates A) are reacted with any desired compounds B) carrying at least one mercapto group. These mercapto-functional compounds B) are any desired monothiols and/or polythiols, which may optionally additionally carry, as a further functional group, at least one hydroxyl group, having an (average) functionality, based on the sum of thiol groups and hydroxyl groups present, of up to 6, preferably from 1 to 4, more preferably from 1 to 3.

Examples of suitable components B) are simple alkanethiols, such as, for example, methyl mercaptan, ethyl mercaptan, allyl mercaptan, methallyl mercaptan, 1-propanethiol, 2-propanethiol, 1-butanethiol, 2-butanethiol, isobutyl mercaptan, tert-butyl mercaptan, 1-pentanethiol, 2-pentanethiol, 2-methyl-1-butanethiol, 3-methyl-1-butanethiol, 1-hexanethiol, 2-hexanethiol, 3-hexanethiol, 4-methylpentan-2-thiol, 3,3-dimethylbutan-1-thiol, 2-ethyl-butan-1-thiol, 4-methyl-1-pentanethiol, 3-methylpentan-2-thiol, 1-heptanethiol, 2-heptanethiol, 1-octathiol, 2-octanethiol, 2-ethyl-1-hexanethiol, 1-nonanethiol, 2-nonanethiol, 1-decanethiol, 3-decanethiol, 1-undecanethiol, undec-10-ene-1-thiol, 1-dodecanethiol, 2-dodecanethiol, tert-dodecylthiol, N-tridecyl mercaptan, 1-tetradecanethiol, tert-tetradecanethiol, 1-pentadecanethiol, 1-hexadecanethiol, heptadecyl mercaptan, 1-octadecanethiol, 1-eicosanethiol, cyclopentanethiol, 2-methylcyclopentane-1-thiol, 3-methylcyclopentane-1-thiol, cyclopentylmethanethiol, 1-cyclopentylethane-1-thiol, cyclohexanethiol, 2-methylcyclohexane-1-thiol, 3-methylcyclohexane-1-thiol, 4-methylcyclohexane-1-thiol, cyclohexylmethanethiol, cycloheptanethiol, 2,3-dimethylcyclohexane-1-thiol, 2,4-dimethylcyclohexane-1-thiol, 2,5-dimethylcyclohexane-1-thiol, 2,6-dimethylcyclohexane-1-thiol, 3,3-dimethylcyclohexane-1-thiol, 4,4-dimethylcyclohexane-1-thiol, 2-ethylcyclohexane-1-thiol, 3-ethylcyclohexane-1-thiol, cyclooctanethiol, bicyclo[2.2.1]heptan-2-ylmethanethiol.methanedithiol, 1,2-ethanedithiol, 1,1-propanedithiol, 1,2-propanedithiol, 1,3-propanedithiol, 2,2-propanedithiol, 1,4-butanedithiol, 2,3-butanedithiol, 1,5-pentanedithiol, 1,6-hexanedithiol, 1,2,3-propanetrithiol, 1,1-cyclohexanedithiol, 1,2-cyclohexanedithiol, 2,2-dimethylpropane-1,3-dithiol, 3,4-dimethoxybutane-1,2-dithiol, and 2-methylcyclohexane-2,3-dithiol, ether thiols, such as, for example, 2-methoxyethanethiol, 2-ethoxyethanethiol, 2-butoxyethanethiol, 2-(3-methylbutoxy)ethanethiol, 2-(2-methoxyethoxy)ethanethiol, bis(2-mercaptoethyl) ether, 2,5,8,11-tetraoxatridecane-13-thiol, 2,5,8,11,14-pentaoxahexadecane-16-thiol, 2,5,8,11,14,17-hexaoxanonadecane-19-thiol and/or 2,5,8,11,14,17,20-heptaoxadocosane-22-thiol, polythiols containing thioether groups, such as, for example, 2,4-dimercaptomethyl-1,5-dimercapto-3-thiapentane, 4-mercaptomethyl-1,8-dimercapto-3,6-dithiaoctane, 4,8-dimercaptomethyl-1,11-dimercapto-3,6,9-trithiaundecane, 4,7-dimercaptomethyl-1,11-dimercapto-3,6,9-trithiaundecane, 5,7-dimercaptomethyl-1,11-dimercapto-3,6,9-trithiaundecane, 5,6-bis(mercaptoethylthio)-1,10-dimercapto-3,8-dithiadecane, 4,5-bis(mercaptoethylthio)-1,10-dimercapto-3,8-dithiadecane, tetrakis(mercaptomethyl)methane, 1,1,3,3-tetrakis(mercaptomethylthio)propane, 1,1,5,5-tetrakis(mercaptomethylthio)-3-thiapentane, 1,1,6,6-tetrakis(mercaptomethylthio)-3,4-dithiahexane, 2-mercaptoethylthio-1,3-dimercaptopropane, 2,3-bis(mercaptoethylthio)-1-mercaptopropane, 2,2-bis(mercaptomethyl)-1,3-dimercaptopropane, bis(mercaptomethyl) sulfide, bis(mercaptomethyl) disulfide, bis(mercaptoethyl) sulfide, bis(mercaptoethyl) disulfide, bis(mercaptopropyl) sulfide, bis(mercaptopropyl) disulfide, bis(mercaptomethylthio)methane, tris(mercaptomethylthio)methane, bis(mercaptoethylthio)methane, tris(mercaptoethylthio)methane, bis(mercaptopropylthio)methane, 1,2-bis(mercaptomethylthio)ethane, 1,2-bis(mercaptoethylthio)ethane, 2-mercaptoethylthio)ethane, 1,3-bis(mercapto-methylthio)propane, 1,3-bis(mercaptopropylthio)propane, 1,2,3-tris(mercaptomethylthio)-propane, 1,2,3-tris(mercaptoethylthio)propane, 1,2,3-tris(mercaptopropylthio)propane, tetrakis(mercaptomethylthio)methane, tetrakis(mercaptoethylthiomethyl)methane, tetrakis(mercaptopropylthiomethyl)methane, 2,5-dimercapto-1,4-dithiane, 2,5-bis(mercaptomethyl)-1,4-dithiane and its oligomers obtainable according to JP-A 07118263, 1,5-bis(mercaptopropyl)-1,4-dithiane, 1,5-bis(2-mercaptoethylthiomethyl)-1,4-dithiane, 2-mercaptomethyl-6-mercapto-1,4-dithiacycloheptane, 2,4,6-trimercapto-1,3,5-trithiane, 2,4,6-trimercaptomethyl-1,3,5-trithiane, and 2-(3-bis(mercaptomethyl)-2-thiapropyl)-1,3-dithiolane, polyester thiols, such as, for example, ethyl 2-mercaptoacetate, propyl 2-mercaptoacetate, ethylene glycol bis(2-mercaptoacetate), ethylene glycol bis(3-mercaptopropionate), diethylene glycol 2-mercaptoacetate, diethylene glycol 3-mercaptopropionate, 2,3-dimercapto-1-propanol 3-mercaptopropionate, 3-mercapto-1,2-propanediol bis(2-mercaptoacetate), 3-mercapto-1,2-propanediol bis(3-mercaptopropionate), trimethylolpropane tris(2-mercaptoacetate), trimethylolpropane tris(3-mercaptopropionate), trimethylolethane tris(2-mercaptoacetate), trimethylolethane tris(3-mercaptopropionate), pentaerythritol tetrakis(2-mercaptoacetate), pentaerythritol tetrakis(3-mercaptopropionate), glycerol tris(2-mercaptoacetate), glycerol tris(3-mercaptopropionate), 1,4-cyclohexanediol bis(2-mercaptoacetate), 1,4-cyclohexanediol bis(3-mercaptopropionate), hydroxymethyl sulfide bis(2-mercaptoacetate), hydroxymethyl sulfide bis(3-mercaptopropionate), hydroxyethyl sulfide (2-mercaptoacetate), hydroxyethyl sulfide (3-mercaptopropionate), hydroxymethyl disulfide(2-mercaptoacetate), hydroxymethyl disulfide (3-mercaptopropionate), 2-mercaptoethyl thioglycolate, bis(2-mercaptoethyl)thiodipropionate, and tris[2-(3-mercaptopropionyloxy)ethyl]isocyanurates, aromatic thio compounds, such as, for example, 1,2-dimercaptobenzene, 1,3-dimercaptobenzene, 1,4-dimercaptobenzene, 1,2-bis(mercaptomethyl)benzene, 1,4-bis(mercaptomethyl)benzene, 1,2-bis(mercaptoethyl)benzene, 1,4-bis(mercaptoethyl)-benzene, 1,2,3-trimercaptobenzene, 1,2,4-trimercaptobenzene, 1,3,5-trimercaptobenzene, 1,2,3-tris-(mercaptomethyl)benzene, 1,2,4-tris(mercaptomethyl)benzene, 1,3,5-tris(mercaptomethyl)benzene, 1,2,3-tris(mercaptoethyl)benzene, 1,3,5-tris(mercapto-ethyl)benzene, 1,2,4-tris(mercaptoethyl)benzene, 2,5-toluenedithiol, 3,4-toluenedithiol, 1,4-naphthalinedithiol, 1,5-naphthalinedithiol, 2,6-naphthalinedithiol, 2,7-naphthaline-dithiol, 1,2,3,4-tetramercaptobenzene, 1,2,3,5-tetraercaptobenzene, 1,2,4,5-tetra-mercaptobenzene, 1,2,3,4-tetrakis(mercaptomethyl)benzene, 1,2,3,5-tetrakis-(mercaptomethyl)benzene, 1,2,4,5-tetrakis(mercaptomethyl)benzene, 1,2,3,4-tetrakis-(mercaptoethyl)benzene, 1,2,3,5-tetrakis(mercaptoethyl)benzene, 1,2,4,5-tetrakis-(mercaptoethyl)benzene, 2,2′-dimercaptobiphenyl, and 4,4′-dimercaptobiphenyl, and also hydroxythiols, such as, for example, 2-mercaptoethanol, 3-mercapto-1-propanol, 2-mercapto-1-propanol, 1-mercapto-2-propanol, 4-mercapto-1-butanol, 1-mercaptobutan-2-ol, 6-mercapto-1-hexanol, 8-mercapto-1-octanol, 9-mercapto-1-nonanol, 11-mercapto-1-undecanol, 1-mercaptododecan-2-ol, 16-mercapto-1-hexadecanol, 1-mercaptohexadecan-2-ol, 1,3-dimercapto-2-propanol, 2,3-dimercaptopropanol, dithioerythritol, 2-mercaptoethoxyethanol, and 2-hydroxyethyl mercaptoacetate.

For the purposes of the present invention, mercapto-functional compounds B) having additionally at least one hydroxyl group are also taken to include blends of the above-exemplified thiols with monools and polyols, provided the resultant blends conform to the details given above concerning the (average) functionality.

Suitable monools and polyols which can be blended with thiols of the stated kind to give mercapto-functional compounds B) are, for example, simple polyhydric alcohols having 2 to 14, preferably 4 to 10, carbon atoms, such as, for example, 1,2-ethanediol, 1,2- and 1,3-propanediol, the isomeric butanediols, pentanediols, hexanediols, heptanediols, and octanediols, 1,10-decanediol, 1,12-dodecanediol, 1,2- and 1,4-cyclohexanediol, 1,4-cyclohexanedimethanol, 1,4-bis(2-hydroxyethoxy)benzene, 2,2-bis(4-hydroxyphenyl)propane (bisphenol A), 2,2-bis(4-hydroxycyclohexyl)propane (perhydrobisphenol), 1,2,3-propanetriol, 1,2,4-butanetriol, 1,1,1-trimethylolethane, 1,2,6-hexanetriol, 1,1,1-trimethylolpropane (TMP), bis(2-hydroxyethyl)hydroquinone, 1,2,4- and 1,3,5-trihydroxycyclohexane, 1,3,5-tris(2-hydroxyethyl)isocyanurate, 3(4), 8(9)-bis(hydroxymethyl)tricyclo[5.2.1.02,6]decanes, ditrimethylolpropane, 2,2-bis(hydroxyl-methyl)-1,3-propanediol (pentaerythritol), 2,2,6,6-tetrakis(hydroxymethyl)-4-oxaheptane-1,7-diol (dipentaerythritol), mannitol or sorbitol, low molecular mass ether alcohols, such as, for example, diethylene glycol, triethylene glycol, tetraethylene glycol, dipropylene glycol, and dibutylene glycol, or low molecular mass ester alcohols, such as, for example, neopentyl glycol hydroxypivalate.

However, mercapto-functional compounds B) that are likewise suitable for the process of the invention also, moreover, include blends of thiols of the type stated with the customary polymeric polyether polyols, polyester polyols, polycarbonate polyols and/or polyacrylate polyols which are known from polyurethane chemistry and which customarily have a number-average molecular weight of 200 to 22 000, preferably of 250 to 18 000, more preferably of 250 to 12 000, provided they conform to the details given above concerning the (average) functionality.

Preferred mercapto-functional compounds B) are polythioetherthiols, polyesterthiols, and hydroxythiols of the stated kind. Particularly preferred compounds B) are bis(mercaptoethyl) sulfide, 4-mercaptomethyl-1,8-dimercapto-3,6-dithiaoctane, ethylene glycol bis(2-mercaptoacetate), ethylene glycol bis(3-mercaptopropionate), trimethylolpropane tris(2-mercaptoacetate), trimethylolpropane tris(3-mercapto-propionate), tris[2-(3-mercaptopropionyloxy)ethyl]isocyanurate, pentaerythritol tetrakis(2-mercaptoacetate), pentaerythritol tetrakis(3-mercaptopropionate), and 2-mercaptoethanol.

For implementing the process of the invention, the di- and/or polyisocyanates A) are reacted with the mercapto-functional compounds B) at temperatures of 20 to 200° C., preferably 40 to 160° C., while observing an equivalents ratio of isocyanate groups to isocyanate-reactive groups (mercapto groups and, where present, hydroxyl groups) of 4:1 to 200:1, preferably of 5:1 to 50:1, more preferably 5:1 to 40:1, to give thioallophanates.

Any hydroxyl groups additionally present in component B) are consumed by reaction during the process of the invention, in a known way, to form allophanate groups. Below, therefore, the terms “thiourethanization” and “thioallophanatization” are also intended to encompass the reactions of hydroxyl groups that may proceed in parallel, to give urethanes and allophanates.

The process of the invention may be carried out without catalysis, as a thermally induced thioallophanatization. Preferably, however, suitable catalysts C) are employed in order to accelerate the thioallophanatization reaction. These catalysts are the customary allophanatization catalysts known from polyurethane chemistry, examples being metal carboxylates, metal chelates, or tertiary amines of the type described in GB-A-0 994 890, or alkylating agents of the type described in U.S. Pat. No. 3,769,318, or strong acids, as described by way of example in EP-A-0 000 194.

Suitable thioallophanatization catalysts C) are, in particular, zinc compounds, such as, for example, zinc(II) stearate, zinc(II) n-octanoate, zinc(II) 2-ethyl-1-hexanoate, zinc(II)-naphthenate, or zinc(II) acetylacetonate, tin compounds, such as, for example, tin(II) n-octanoate, tin(II) 2-ethyl-1-hexanoate, tin(II) laurate, dibutyltin oxide, dibutyltin dichloride, dibutyltin diacetate, dibutyltin dilaurate, dibutyltin dimaleate, or dioctyltin diacetate, zirconium compounds, such as, for example, zirconium(IV) 2-ethyl-1-hexanoate, zirconium(IV) neodecanoate, zirconium(IV) naphthenate, or zirconium(IV) acetylacetonate, aluminum tri(ethyl acetoacetate), iron(III) chloride, potassium octoate, manganese compounds cobalt compounds, or nickel compounds, and also strong acids, such as, for example, trifluoroacetic acid, sulfuric acid, hydrogen chloride, hydrogen bromide, phosphoric acid, or perchloric acid, or any desired mixtures of these catalysts.

Suitable, albeit less preferred, catalysts C) for the process of the invention also include those compounds which as well as the thioallophanatization reaction also catalyze the trimerization of isocyanate groups to form isocyanurate structures. Catalysts of this kind are described for example in EP-A-0 649 866 page 4, line 7 to page 5, line 15.

Preferred catalysts C) for the process of the invention are zinc compounds and/or zirconium compounds of the aforementioned kind. Especially preferred is the use of zinc(II) n-octanoate, zinc(II) 2-ethyl-1-hexanoate and/or zinc(II) stearate, zirconium(IV) n-octanoate, zirconium(IV) 2-ethyl-1-hexanoate and/or zirconium(IV) neodecanoate.

Catalysts C) are employed in the process of the invention, if at all, preferably in an amount of 0.001 to 5 wt %, more preferably 0.005 to 1 wt %, based on the total weight of the reactants A) and B), and may be added not only prior to commencement of reaction but also at any point in time during the reaction.

The process of the invention is preferably carried out solventlessly. Optionally, however, suitable solvents, inert toward the reactive groups of the starting components, may also be used. Examples of suitable solvents are the customary paint solvents known per se, such as, for example, ethyl acetate, butyl acetate, ethylene glycol monomethyl or monoethyl ether acetate, 1-methoxy-2-propyl acetate (MPA), 3-methoxy-n-butyl acetate, acetone, 2-butanone, 4-methyl-2-pentanone, cyclohexanone, toluene, xylene, chlorobenzene, white spirit, relatively highly substituted aromatics, as sold for example under the names Solvent naphtha, SOLVESSO, ISOPAR, NAPPAR (ExxonMobil Chemical Central Europe, Cologne, DE) and SHELLSOL (Shell Deutschland Oil GmbH, Hamburg, DE), but also solvents such as propylene glycol diacetate, diethylene glycol dimethyl ether, dipropylene glycol dimethyl ether, diethylene glycol ethyl and butyl ether acetate, N-methylpyrrolidone and N-methylcaprolactam, or any desired mixtures of such solvents. In one possible embodiment, in the process of the invention, the starting diisocyanate and/or polyisocyanate A), or a mixture of different starting diisocyanates and/or polyisocyanates, is introduced as an initial charge, optionally under inert gas, such as nitrogen, for example, and optionally in the presence of a suitable solvent of the type stated, at a temperature of between 20 and 100° C. Thereafter the mercapto-functional and optionally hydroxy-functional component B), or a mixture of different mercapto-functional and optionally hydroxyl-functional components, is added in the amount indicated above, and the reaction temperature for the thiourethanization is set to a temperature of 30 to 120° C., preferably of 50 to 100° C., where appropriate by means of a suitable measure (heating or cooling). Following the thiourethanization reaction, i.e., when the NCO content reaches that corresponding theoretically to complete conversion of isocyanate, mercapto, and—when present—hydroxyl groups, the thioallophanatization may be initiated, optionally without addition of a catalyst, by heating the reaction mixture to a temperature of 120 to 200° C. Preferably, however, suitable catalysts C) of the aforementioned kind are employed for accelerating the thioallophanatization reaction, in which case, depending on the nature and amount of the catalyst used, temperatures in the range from 60 to 140° C., preferably 70 to 120° C., are sufficient for the implementation of the reaction.

In another possible embodiment of the process of the invention, the catalyst for optional use is admixed either to the diisocyanate component and/or polyisocyanate component A) and/or to the mercapto-functional component B) even before the actual reaction has commenced. In this case, the thiourethane groups which form as intermediates undergo spontaneous onward reaction to form the desired thioallophanate structure. With this kind of single-stage reaction regime, the isocyanate component A), optionally including the catalyst, is introduced optionally under inert gas, such as nitrogen, for example, and optionally in the presence of a suitable solvent of the type stated, generally at temperatures which are optimum for the thioallophanatization, in the range from 60 to 140° C., preferably 70 to 120° C., and is reacted with the mercapto-functional component B), optionally including the catalyst.

It is also possible, however, to add the catalyst to the reaction mixture at any point during the thiourethanization reaction. In the case of this embodiment of the process of the invention, the temperature set for the pure thiourethanization reaction, occurring before the addition of catalyst, is generally in the range from 30 to 120° C., preferably from 50 to 100° C. Following addition of an appropriate catalyst, finally, the thioallophanatization reaction is conducted at temperatures of 60 to 140° C., preferably of 70 to 120° C.

In the process of the invention, the course of the reaction may be monitored by means, for example, of titrimetric determination of the NCO content. When the target NCO content has been reached, preferably when the degree of conversion (that is, the percentage fraction of the thiourethane groups and optionally urethane groups that form as intermediates from the mercapto groups and optionally hydroxyl groups of component B), to give thioallophanate groups and optionally allophanate groups, as may be computed from the NCO content) of the reaction mixture is at least 80%, more preferably at least 90%, very preferably after complete thioallophanatization, the reaction is terminated. In the case of a purely thermal reaction regime, this may be accomplished, for example, by cooling the reaction mixture to room temperature. In the case of the preferred use of a thioallophanatization catalyst C) of the type stated, however, the reaction is generally stopped by addition of suitable catalyst poisons.

Examples of such catalyst poisons are inorganic acids such as hydrochloric acid, phosphorous acid or phosphoric acid, acyl chlorides such as acetyl chloride, benzoyl chloride, or isophthaloyl dichloride, sulfonic acids and sulfonic esters, such as methanesulfonic acid, p-toluenesulfonic acid, trifluoromethanesulfonic acid, perfluorobutanesulfonic acid, dodecylbenzenesulfonic acid, methyl and ethyl p-toluenesulfonate, monoalkyl and dialkyl phosphates such as monotridecyl phosphate, dibutyl phosphate, and dioctyl phosphate, and also silylated acids, such as trimethylsilyl methanesulfonate, trimethylsilyl trifluoromethanesulfonate, tris(trimethylsilyl) phosphate, and diethyl trimethylsilyl phosphate.

The amount of the catalyst poison needed in order to stop the reaction is dependent on the amount of catalyst used; in general, an equivalent amount of the stopping agent is used, based on the oligomerization catalyst used at the beginning. However, taking account of any catalyst losses occurring during the reaction, it is possible that just 20 to 80 equivalent % of the catalyst poison, based on the amount of catalyst originally employed, is sufficient to halt the reaction.

When monomeric diisocyanates are used as starting component A), the reaction mixture is subsequently freed from volatile constituents (excess monomeric diisocyanates, any solvents used, and, where no catalyst poison is used, any active catalyst) preferably by means of thin-film distillation under a high vacuum, as for example under a pressure of below 1.0 mbar, preferably below 0.5 mbar, more preferably below 0.2 mbar, under very gentle conditions, as for example at a temperature of 100 to 200° C., preferably of 120 to 180° C.

The distillates obtained, which as well as the unreacted monomeric starting diisocyanates, comprise any solvents used, and any active catalyst where no catalyst poison is employed, may be used without problems for a further oligomerization.

In another embodiment of the process of the invention, the stated volatile constituents are removed from the oligomerization product by extraction with suitable solvents inert toward isocyanate groups, examples being aliphatic or cycloaliphatic hydrocarbons such as pentane, hexane, heptane, cyclopentane, or cyclohexane.

Where the known polyisocyanates which are of low monomer content, are composed of at least two diisocyanates, and have uretdione, isocyanurate, allophanate, biuret, iminooxadiazinedione and/or oxadiazinetrione structures are used as starting component

A), there is generally no need for this last step of the distillative or extractive purification step.

Independently of the way in which working up is carried out, products obtained from the process of the invention are clear, virtually colorless thioallophanate polyisocyanates, with color numbers generally of below 120 APHA, preferably of below 80 APHA, more preferably of below 60 APHA, and with an NCO content of 5.0 to 21.0 wt %, preferably 7.0 to 20.0 wt %, more preferably 10.0 to 19.0 wt %. The average NCO functionality here may vary over a wide range, depending on the thiol component used, the nature of the thioallophanatization catalyst, and the degree of conversion, and is generally from 1.8 to 10.0, preferably from 1.8 to 9.0, more preferably from 2.0 to 8.0.

The amount of thioallophanate structures (calculated as —NH—CO—N—CO—S—; mol. weight=117 g/mol) in the polyisocyanates of the invention is from 0.5 to 45 wt %, preferably from 1 to 40 wt % and more preferably from 3 to 35 wt %.

The thioallophanate polyisocyanates of the invention are valuable starting materials for the production of polyurethane, polythiourethane and/or polyurea plastics via the isocyanate polyaddition process.

They can be used there solventlessly, but as and when required may also be diluted to a nonturbid form using customary solvents, examples being the abovementioned inert paint solvents for optional accompanying use in the process of the invention.

The thioallophanate polyisocyanates of the invention are outstandingly suitable as crosslinker components for two-component polyurethane paints, where polyhydroxyl compounds present as coreactants for the polyisocyanates are the customary polyether polyols, polyester polyols polycarbonate polyols and/or polyacrylate polyols. Particularly preferred coreactants for the process products of the invention are polyacrylates having hydroxyl groups, i.e., polymers and/or copolymers of (meth)acrylic acid alkyl esters, optionally with styrene or other copolymerizable olefinically unsaturated monomers.

In general, the coating compositions formulated with the thioallophanate polyisocyanates of the invention, said compositions possibly, optionally, having the auxiliaries and additives customary in the paint sector incorporated into them, such as flow control assistants, color pigments, fillers, or matting agents, for example, possess good paint-related properties even with room-temperature drying. Of course, however, they may also be dried under forced conditions at elevated temperature or by baking at temperatures up to 260° C.

In order to control the rate of cure, suitable catalysts may be used when formulating the coating compositions, examples being the catalysts customary in isocyanate chemistry, such as, for example, tertiary amines such as triethylamine, pyridine, methylpyridine, benzyldimethylamine, N,N-endoethylenepiperazine, N-methylpiperidine, pentamethyldiethylenetriamine, N,N-dimethylaminocyclohexane, N,N′-dimethylpiperazine, or metal salts such as iron(III) chloride, zinc chloride, zinc 2-ethylcaproate, tin(II) octanoate, tin(II) ethylcaproate, dibutyltin(IV) dilaurate, bismuth(III) 2-ethylhexanoate, bismuth(III) octoate, or molybdenum glycolate.

Of course, the polyisocyanates of the invention having thioallophanate structure may also be employed in a form in which they are blocked with blocking agents known per se from polyurethane chemistry, in combination with the aforementioned paint binders or paint-binder components, to form one-component PUR baking systems. Examples of suitable blocking agents are diethyl malonate, ethyl acetoacetate, activated cyclic ketones, such as cyclopentanone-2-carboxymethyl ester and -carboxyethyl ester, acetone oxime, butanone oxime, ε-caprolactam, 3,5-dimethylpyrazole, 1,2,4-triazole, dimethyl-1,2,4-triazole, imidazole, benzyl-tert-butylamine, or any desired mixtures of these blocking agents.

The process products of the invention may also be combined with polyamines, such as the polyaspartic acid derivatives known from EP-B 0 403 921, for example, or else with polyamines whose amino groups are in blocked form, such as polyketimines, polyaldimines, or oxazolanes, for example. Under the influence of moisture, free amino groups are formed from these blocked amino groups, and, in the case of the oxazolanes, free hydroxyl groups as well, and are consumed in a crosslinking reaction with the thioallophanate polyisocyanates.

To produce coatings or moldings featuring particularly high refraction of light, the thioallophanate polyisocyanates of the invention may also be reacted to form polythiourethanes, reaction taking place with any desired polythiols, more particularly polythioetherthiols and polyesterthiols, such as, for example, 4-mercaptomethyl-1,8-dimercapto-3,6-dithiaoctane, 2,5-bismercaptomethyl-1,4-dithiane, 1,1,3,3-tetrakis(mercaptomethylthio)propane, 5,7-dimercaptomethyl-1,11-dimercapto-3,6,9-trithiaundecane, 4,7-dimercaptomethyl-1,11-dimercapto-3,6,9-trithiaundecane, 4,8-di-mercaptomethyl-1,11-dimercapto-3,6,9-trithiaundecane, trimethylolpropane tris(3-mercaptopropionate), trimethylolethane tris(2-mercaptoacetate), pentaerythritol tetrakis(2-mercaptoacetate), and pentaerythritol tetrakis(3-mercaptopropionate).

The thioallophanate polyisocyanates of the invention are also suitable as crosslinker components for binders or binder components that are present in dispersion or solution in water and have groups reactive toward isocyanate groups, more particularly alcoholic hydroxyl groups, in the production of aqueous two-component polyurethane systems. In this case they may be used either as such, i.e., in hydrophobic form, or else in a form in which they have been hydrophilically modified by known techniques, as for example in accordance with EP-B 0 540 985, EP-B 0 959 087, or EP-B 1 287 052.

In all of the uses described above for the thioallophanate polyisocyanates of the invention, they may be employed as an isocyanate component either alone or else in a blend with any other polyisocyanates having aliphatically, cycloaliphatically, araliphatically and/or aromatically bonded isocyanate groups, more particularly the known paint polyisocyanates having uretdione, isocyanurate, iminooxadiazinedione, urethane, allophanate, biuret and/or oxadiazinetrione structure, as described by way of example in Laas et al., J. Prakt. Chem. 336, 1994, 185-200, in DE-A 1 670 666, DE-A 3 700 209, DE-A 3 900 053, EP-A 0 330 966, EP-A 0 336 205, EP-A 0 339 396, and EP-A 0 798 299.

In two-component polyurethane and/or polyurea paints and coatings which comprise the thioallophanate polyisocyanates of the invention as crosslinker components or part of crosslinker components for polyols and/or polyamines, the coreactants are customarily present in amounts such that for each optionally blocked isocyanate group there are 0.5 to 3, preferably 0.6 to 2.0, more preferably 0.8 to 1.6 optionally blocked, isocyanate-reactive groups.

Substrates contemplated for the coatings formulated with the aid of the thioallophanate polyisocyanates of the invention are any desired substrates, such as, for example, metal, wood, glass, stone, ceramic materials, concrete, rigid and flexible plastics, textiles, leather, and paper, which prior to coating may also, optionally, be provided with customary primers.

Further subjects of this invention are therefore coating compositions comprising the thioallophanate polyisocyanates of the invention, and also the substrates coated with these coating compositions.

### EXAMPLES

All percentages are by weight unless noted otherwise.

The NCO contents were determined by titrimetry in accordance with DIN EN ISO 11909.

The residual monomer contents were measured in accordance with DIN EN ISO 10283 by gas chromatography with an internal standard.

All of the viscosity measurements took place using a PHYSICA MCR 51 Rheometer from Anton Paar Germany GmbH (DE) in accordance with DIN EN ISO 3219.

The amounts (mol %) of the isocyanate derivatives formed under the process conditions of the invention, namely thiourethane, thioallophanate, urethane, allophanate, and isocyanurate, were calculated from the integrals of proton-decoupled ¹³C-NMR spectra (recorded on a BRUKER DPX-400 instrument) and are each based, unless otherwise noted, on the sum of thiourethane, thioallophanate, and isocyanurate groups present. The individual structural elements have the following chemical shifts (in ppm): thiourethane: 166.8; thioallophanate: 172.3 and 152.8; urethane: 156.3; allophanate: 155.7 and 153.8; isocyanurate: 148.4.

The average isocyanate functionalities stated for the process products of the invention are arithmetic values derived from the functionalities of the ideal parent structures.

The amounts (weight %) of thioallophanate structures were calculated as —NH—CO—N—CO—S— with mol. weight=117 g/mol.

### Example 1 (Inventive)

1680 g (10 mol) of hexamethylene diisocyanate (HDI) were introduced at a temperature of 80° C. under dry nitrogen and with stirring, and 0.1 g of zinc(II) 2-ethyl-1-hexanoate was added as catalyst. Over a period of approximately 30 minutes, 119 g (0.5 mol) of ethylene glycol bis(3-mercaptopropionate) were added dropwise, the temperature of the mixture rising to 85° C. because of the reaction, which begins exothermically. The reaction mixture was stirred further at 85° C. until after about 3 hours, the NCO content had dropped to 42.0%. The catalyst was deactivated by addition of 0.1 g of orthophosphoric acid, and the unreacted monomeric HDI was separated off in a thin-film evaporator at a temperature of 130° C. under a pressure of 0.1 mbar. This gave 434 g of a virtually colorless, clear polyisocyanate mixture, whose characteristic data and composition were as follows:

NCO content: 17.1%

Monomeric HDI: 0.18%

Viscosity (23° C.): 9.040 mPas

Average NCO functionality: >4

Thiourethane: 0.0 mol %

Thioallophanate: 98.4 mol %

Isocyanurate groups: 1.6 mol %

Amount of thioallophanate structures: 26.9%

### Example 2 (Inventive)

By the process described in Example 1, 3360 g (20 mol) of HDI were reacted in the presence of 0.3 g of zinc(II) 2-ethyl-1-hexanoate with 133 g (0.33 mol) of trimethylolpropane tris(3-mercaptopropionate) at a temperature of 85° C. until the NCO content was 45.7%. After the reaction had been halted using 0.3 g of orthophosphoric acid, and after distillative workup in a thin-film evaporator, 467 g of a virtually colorless, clear polyisocyanate mixture were obtained, whose characteristic data and composition were as follows:

NCO content: 17.6%

Monomeric HDI: 0.42%

Viscosity (23° C.): 20 200 mPas

Average NCO functionality: >6

Thiourethane: 0.0 mol %

Thioallophanate: 95.2 mol %

Isocyanurate groups: 4.8 mol %

Amount of thioallophanate structures: 25.2%

### Example 3 (Inventive)

By the process described in Example 1, 1008 g (6 mol) of HDI were reacted in the presence of 0.1 g of zinc(II) 2-ethyl-1-hexanoate with 202 g (1.0 mol) of dodecanethiol at a temperature of 85° C. until the NCO content was 34.7%. After the reaction had been halted using 0.1 g of orthophosphoric acid, and after distillative workup in a thin-film evaporator, 478 g of a virtually colorless, clear polyisocyanate mixture were obtained, whose characteristic data and composition were as follows:

NCO content: 13.5%

Monomeric HDI: 0.03%

Viscosity (23° C.): 218 mPas

Average NCO functionality: 2

Thiourethane: 8.0 mol %

Thioallophanate: 91.1 mol %

Isocyanurate groups: 0.9 mol %

Amount of thioallophanate structures: 22.3%

### Example 4 (Inventive)

940 g (1.6 mol) of a polyisocyanurate polyisocyanate based on HDI and having an NCO content of 22.8%, an average NCO functionality of 3.2, a monomeric HDI content of 0.07%, and a viscosity of 1210 mPas were introduced at a temperature of 80° C. under dry nitrogen and with stirring, and 0.1 g of zinc(II) 2-ethyl-1-hexanoate was added as catalyst. Over a period of approximately 10 minutes, 60 g (0.3 mol) of dodecanethiol were added dropwise, the temperature of the mixture rising to 93° C. because of the reaction, which begins exothermically. The reaction mixture was stirred further at 90° C. until after about 5 hours, the NCO content had dropped to 18.9%. The catalyst was then deactivated by addition of 0.1 g of orthophosphoric acid. The resulting polyisocyanate mixture was clear with a weak yellowish color, and its characteristic data and composition were as follows:

NCO content: 18.9%

Monomeric HDI: 0.06%

Viscosity (23° C.): 5480 mPas

Average NCO functionality: 3.5

Thiourethane: 15.3 mol %

Thioallophanate: 84.7 mol %

Amount of thioallophanate structures: 3.5%

The molar fractions stated for isocyanate derivatives in this example refer in each case only to the sum of thiourethane groups and thioallophanate groups, since the isocyanurate structures already present originally in the starting polyisocyanate does not allow reliable quantification of the isocyanurate groups newly formed as a secondary component under the reaction conditions.

### Example 5 (Inventive)

1680 g (10 mol) of HDI were introduced at a temperature of 80° C. under dry nitrogen and with stirring, and 0.1 g of zinc(II) 2-ethyl-1-hexanoate was added as catalyst. Over a period of approximately 30 minutes, 124 g (1.0 mol) of p-thiocresol were added in portions at a rate such that the temperature of the mixture, on the basis of the reaction which sets in exothermically, did not exceed 85° C. The reaction mixture was subsequently stirred further at 85° C. until after about 5 hours, the NCO content had dropped to 41.9%. The catalyst was deactivated by addition of 0.1 g of orthophosphoric acid, and the unreacted monomeric HDI was separated off in a thin-film evaporator at a temperature of 130° C. under a pressure of 0.1 mbar. This gave 402 g of a slightly yellow-colored clear polyisocyanate mixture, whose characteristic data and composition were as follows:

NCO content: 15.5%

Monomeric HDI: 0.13%

Viscosity (23° C.): 3280 mPas

Average NCO functionality: 2

Thiourethane: 10.0 mol %

Thioallophanate: 89.3 mol %

Isocyanurate groups: 0.7 mol %

Amount of thioallophanate structures: 26.2%

### Example 6 (Inventive)

840 g (5 mol) of HDI were introduced at a temperature of 100° C. under dry nitrogen and with stirring, and 0.14 g of zinc(II) 2-ethyl-1-hexanoate was added as catalyst. Over a period of approximately 30 minutes, 119 g (0.5 mol) of ethylene glycol bis(3-mercaptopropionate) were added dropwise, the temperature of the mixture rising to 110° C. because of the reaction, which begins exothermically. The reaction mixture was stirred further at 110° C. until after about 8 hours, the NCO content had dropped to 34.6%. The catalyst was deactivated by addition of 0.5 g of benzoyl chloride, and the unreacted monomeric HDI was separated off in a thin-film evaporator at a temperature of 110° C. under a pressure of 0.1 mbar. This gave 413 g of a virtually colorless, clear polyisocyanate mixture, whose characteristic data and composition were as follows:

NCO content: 15.1%

Monomeric HDI: 0.03%

Viscosity (23° C.): 24 400 mPas

Average NCO functionality: >4

Thiourethane: 3.1 mol %

Thioallophanate: 96.1 mol %

Isocyanurate groups: 0.8 mol %

Amount of thioallophanate structures: 27.2%

### Example 7 (Inventive)

By the process described in Example 6, 840 g (5 mol) of HDI were reacted in the presence of 0.05 g of zinc(II) 2-ethyl-1-hexanoate with 87 g (0.33 mol) of 2,3-di((2-mercaptoethyl)thio)-1-propanethiol at a temperature of 80° C. until the NCO content was 35.8%. After the reaction had been halted using 0.5 g of benzoyl chloride, and after distillative workup in a thin-film evaporator, 382 g of a virtually colorless, clear polyisocyanate mixture were obtained, whose characteristic data and composition were as follows:

NCO content: 16.5%

Monomeric HDI: 0.05%

Viscosity (23° C.): 360 000 mPas

Average NCO functionality: >6

Thiourethane: 0.0 mol %

Thioallophanate: 98.6 mol %

Isocyanurate groups: 1.4 mol %

Amount of thioallophanate structures: 30.2%

### Example 8 (Inventive)

840 g (5 mol) of HDI were introduced at a temperature of 80° C. under dry nitrogen and with stirring. Over a period of approximately 60 minutes, 77 g (0.5 mol) of bis(2-mercaptoethyl) sulfide were added dropwise. The reaction mixture was stirred further at 140° C. until after about 6 hours, the NCO content had dropped to 34.6%. The unreacted monomeric HDI was separated off in a thin-film evaporator at a temperature of 110° C. under a pressure of 0.1 mbar. This gave 392 g of a virtually colorless, clear polyisocyanate mixture, whose characteristic data and composition were as follows:

NCO content: 17.7%

Monomeric HDI: 0.11%

Viscosity (23° C.): 8200 mPas

Average NCO functionality: >4

Thiourethane: 13.4 mol %

Thioallophanate: 86.6 mol %

Isocyanurate groups: 0.0 mol %

Amount of thioallophanate structures: 25.8%

### Example 9 (Inventive)

By the process described in Example 6, 840 g (5 mol) of HDI were reacted in the presence of 0.05 g of zinc(II) 2-ethyl-1-hexanoate with 91 g (0.5 mol) of 3,6-dioxa-1,8-octanedithiol at a temperature of 80° C. until the NCO content was 36.5%. After the reaction had been halted using 0.5 g of benzoyl chloride, and after distillative workup in a thin-film evaporator, 399 g of a virtually colorless, clear polyisocyanate mixture were obtained, whose characteristic data and composition were as follows:

NCO content: 16.6%

Monomeric HDI: 0.03%

Viscosity (23° C.): 7750 mPas

Average NCO functionality: >4

Thiourethane: 8.0 mol %

Thioallophanate: 92.0 mol %

Isocyanurate groups: 0.0 mol %

Amount of thioallophanate structures: 27.0%

### Example 10 (Inventive)

By the process described in Example 6, 840 g (5 mol) of HDI were reacted in the presence of 0.1 g of zinc(II) 2-ethyl-1-hexanoate with 41.5 g (0.5 mol) of 2,3-dimercapto-1-propanol at a temperature of 110° C. until the NCO content was 38.1%. After the reaction had been halted using 0.5 g of benzoyl chloride, and after distillative workup in a thin-film evaporator, 354 g of a virtually colorless, clear polyisocyanate mixture were obtained, whose characteristic data and composition were as follows:

NCO content: 18.9%

Monomeric HDI: 0.08%

Viscosity (23° C.): 120 000 mPas

Average NCO functionality: >6

Thiourethane: 2.0 mol %

Urethane: 5.3 mol %

Thioallophanate: 61.0 mol %

Allophanate 30.7 mol %

Isocyanurate groups: 1.0 mol %

Amount of thioallophanate structures: 20.2%

### Example 11 (Inventive)

By the process described in Example 6, 1680 g (10 mol) of HDI were reacted in the presence of 0.05 g of zinc(II) 2-ethyl-1-hexanoate with 87 g (0.33 mol) of 2,3-di((2-mercaptoethyl)thio)-1-propanethiol at a temperature of 80° C. until the NCO content was 41.3%. After the reaction had been halted using 0.5 g of benzoyl chloride, and after distillative workup in a thin-film evaporator, 366 g of a virtually colorless, clear polyisocyanate mixture were obtained, whose characteristic data and composition were as follows:

NCO content: 17.9%

Monomeric HDI: 0.07%

Viscosity (23° C.): 40 000 mPas

Average NCO functionality: >6

Thiourethane: 13.1 mol %

Thioallophanate: 86.4 mol %

Isocyanurate groups: 0.5 mol %

Amount of thioallophanate structures: 27.6%

### Example 12 (Inventive)

1100 g (5 mol) of isophorone diisocyanate (IPDI) were introduced at a temperature of 90° C. under dry nitrogen and with stirring, and 0.1 g of zinc(II) 2-ethyl-1-hexanoate was added as catalyst. Over a period of approximately 15 minutes, 119 g (0.5 mol) of ethylene glycol bis(3-mercaptopropionate) were added dropwise, the temperature of the mixture rising to 103° C. because of the reaction, which begins exothermically. The reaction mixture was stirred further at 105° C. until after about 8 hours, the NCO content had dropped to 32.0%. The catalyst was deactivated by addition of 0.1 g of orthophosphoric acid, and the unreacted monomeric IPDI was separated off in a thin-film evaporator at a temperature of 160° C. under a pressure of 0.2 mbar. This gave 428 g of a high-viscosity, slightly yellow-colored polyisocyanate mixture, whose characteristic data and composition were as follows:

NCO content: 16.9%

Monomeric IPDI: 0.23%

Viscosity (23° C.): 9100 mPas (as 80% solution in MPA)

Average NCO functionality: >4

Thiourethane: 35.0 mol %

Thioallophanate: 65.0 mol %

Isocyanurate groups: 0.0 mol %

Amount of thioallophanate structures: 17.8%

### Example 13 (Inventive, Production of a Coating)

37 g (0.156 eq) of the thioallophanate polyisocyanate from Example 7 were homogenized, using a magnetic stirrer, with 90 g (0.156 eq) of a hydroxy-functional polyacrylate resin with an OH number of 97 mg KOH/g (DESMOPHEN® A 870, Nuplex Resins GmbH) and 73 g of butyl acetate. The mixture was admixed with 0.1 g of dibutyltin dilaurate as curing catalyst, and was stirred for 5 minutes more. Thereafter the mixture was applied, using a four-way bar applicator, in a wet film thickness of 120 μm, to a glass plate, and was cured at 140° C. for 30 minutes. This gave a clear, glossy coating film which had a König pendulum hardness of 200 seconds (measured after 24 hours at 23° C. with a PH-5458 pendulum hardness measuring apparatus from BYK) and showed itself to be fully resistant toward acetone (contact for one minute with acetone-impregnated cotton pad).

Various Aspects of the Subject Matter Described Herein are Set Out in the Following Numbered Clauses:
1. Polyisocyanates having aliphatically, cycloaliphatically, araliphatically and/or aromatically bonded isocyanate groups, comprising thioallophanate structures of the formula (I)

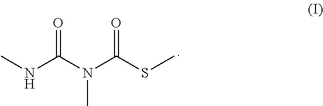

2. The polyisocyanates as in clause 1, characterized in that the amount of thioallophanate structures of the formula (I) is from 0.5 to 45 wt %.
3. A process for preparing polyisocyanates as in one of clauses 1 and 2 by reacting
   A) at least one di- and/or polyisocyanate having aliphatically, cycloaliphatically, araliphatically and/or aromatically bonded isocyanate groups with
   B) at least one compound carrying at least one mercapto group, optionally in the presence of
   C) a catalyst which accelerates the formation of thioallophanate groups,
   while observing an equivalents ratio of isocyanate groups to isocyanate-reactive groups of 4:1 to 200:1.
4. The process as in clause 3, characterized in that diisocyanates having aliphatically and/or cycloaliphatically bonded isocyanate groups are employed as component A).
5. The process as in clause 3, characterized in that 1,5-diisocyanatopentane, 1,6-diisocyanatohexane, 1-isocyanato-3,3,5-trimethyl-5-isocyanatomethylcyclohexane, 2,4′- and/or 4,4′-diisocyanatodicyclohexylmethane or any desired mixtures of these diisocyanates are employed as component A).
6. The process as in any one of clauses 3 to 5, characterized in that monothiols and/or polythiols which optionally additionally carry at least one hydroxyl group, aromatic thio compounds, polythioetherthiols and/or polyesterthiols are employed as component B).
7. The process as in clause 6, characterized in that monothiols and/or polythiols which additionally carry at least one hydroxyl group, polythioetherthiols and/or polyesterthiols are employed as component B).
8. The process as in clause 7, characterized in that bis(mercaptoethyl) sulfide, 4-mercaptomethyl-1,8-dimercapto-3,6-dithiaoctane, ethylene glycol bis(2-mercaptoacetate), ethylene glycol bis(3-mercaptopropionate), trimethylolpropane tris(2-mercaptoacetate), trimethylolpropane tris(3-mercaptopropionate), tris[2-(3-mercaptopropionyloxy)ethyl]isocyanurate, pentaerythritol tetrakis(2-mercaptoacetate), pentaerythritol tetrakis(3-mercaptopropionate) and/or 2-mercaptoethanol are employed as component B).
9. The process as in any one of clauses 3 to 7, characterized in that the reaction is carried out in the presence of a catalyst which accelerates the formation of thioallophanate groups, preferably in the presence of zinc carboxylates and/or zirconium carboxylates.
10. The process as in clause 9, characterized in that zinc(II) n-octanoate, zinc(II) 2-ethyl-1-hexanoate, zinc(II) stearate, zirconium(IV) n-octanoate, zirconium(IV) 2-ethyl-1-hexanoate and/or zirconium(IV) neodecanoate are used as thioallophanatization catalyst.
11. The process as in any one of clauses 3 to 10, characterized in that subsequent to the reaction, excess, unreacted monomeric diisocyanates A) are removed by thin-film distillation from the thioallophanate polyisocyanates.
12. The use of the polyisocyanates having thioallophanate structures as in one of clauses 1 and 2 as starting components in the preparation of polyurethane plastics.
13. Coating compositions comprising polyisocyanates having thioallophanate structures as in one of clauses 1 and 2.
14. Substrates coated with coating compositions as in clause 13.
15. Moldings comprising polyisocyanates with thioallophanate structures as in one of clauses 1 or 2.

1. A polyisocyanate having at least one of an aliphatically, cycloaliphatically, araliphatically and/or aromatically bonded isocyanate groups, comprising a thioallophanate structures of the formula (I)

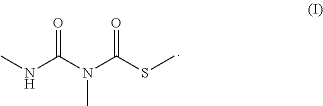

2. The polyisocyanates according to claim 1, wherein the amount of thioallophanate structures of the formula (I) comprise from 0.5 to 45 wt %.

3. A process for preparing a polyisocyanates according to claim 1, the process comprising reacting:
A) at least one di- and/or polyisocyanate having aliphatically, cycloaliphatically, araliphatically and/or aromatically bonded isocyanate groups with
B) at least one compound carrying at least one mercapto group, optionally in the presence of
C) a catalyst which accelerates the formation of thioallophanate groups,
at an equivalents ratio of isocyanate groups to isocyanate-reactive groups of 4:1 to 200:1.

4. The process according to claim 3, wherein a component A) comprises a diisocyanate having aliphatically and/or cycloaliphatically bonded isocyanate groups.

5. The process according to claim 3, wherein component A) is selected from the group consisting of 1,5-diisocyanatopentane, 1,6-diisocyanatohexane, 1-isocyanato-3,3,5-trimethyl-5-isocyanatomethylcyclohexane, 2,4′- and/or 4,4′-diisocyanatodicyclohexylmethane or any desired mixtures of these diisocyanates.

6. The process according to claim 3, wherein component B) is selected from the group consisting of monothiols and polythiols which optionally additionally carry at least one hydroxyl group, aromatic thio compounds, polythioetherthiols and polyesterthiols.

7. The process according to claim 6, wherein component B) is selected from the group consisting of monothiols and polythiols which additionally carry at least one hydroxyl group, polythioetherthiols and polyesterthiols.

8. The process according to claim 7, wherein component B) is selected from the group consisting of bis(mercaptoethyl) sulfide, 4-mercaptomethyl-1,8-dimercapto-3,6-dithiaoctane, ethylene glycol bis(2-mercaptoacetate), ethylene glycol bis(3-mercaptopropionate), trimethylolpropane tris(2-mercaptoacetate), trimethylolpropane tris(3-mercaptopropionate), tris[2-(3-mercaptopropionyloxy)ethyl]isocyanurate, pentaerythritol tetrakis(2-mercaptoacetate), pentaerythritol tetrakis(3-mercaptopropionate) and 2-mercaptoethanol.

9. The process according to claim 3, wherein the reaction is carried out in the presence of a catalyst which accelerates the formation of thioallophanate groups.

10. The process according to claim 9, wherein the thioallophanatization catalyst is selected from the group consisting of zinc(II) n-octanoate, zinc(II) 2-ethyl-1-hexanoate, zinc(II) stearate, zirconium(IV) n-octanoate, zirconium(IV) 2-ethyl-1-hexanoate and zirconium(IV) neodecanoate.

11. The process according to claim 3, wherein subsequent to the reaction, excess, unreacted monomeric diisocyanates A) is removed by thin-film distillation from the thioallophanate polyisocyanate.

12. In a process for the preparation of polyurethane plastics, the improvement comprising including the polyisocyanates having thioallophanate structures according to claim 1 as starting components.

13. A coating composition comprising the polyisocyanates having thioallophanate structures according to claim 1.

14. A substrate coated with the coating composition according to claim 13.

15. A molding comprising the polyisocyanate with thioallophanate structures according to claim 1.

16. The process according to claim 3, wherein the reaction is carried out in the presence of a zinc carboxylate and/or a zirconium carboxylate.
